(19) United States
(12) Patent Application Publication
(10) Pub. No.: US 2023/0180651 A1
(43) Pub. Date: Jun. 15, 2023

(54) BIOMECHANICAL MEASURING TECHNICAL METHOD FOR MAIZE SEED RADICLE AND COLEORHIZA SEPARATION

(71) Applicants: Qingdao Agricultural University, Qingdao (CN); Royal Holloway University of London, Surrey (GB)

(72) Inventors: Xuwen Jiang, Qingdao (CN); Heqin Li, Qingdao (CN); Tina STEINBRECHER, Surrey (GB); Gerhard LEUBNER-METZGER, Surrey (GB)

(21) Appl. No.: 18/080,224

(22) Filed: Dec. 13, 2022

(30) Foreign Application Priority Data
Dec. 14, 2021 (CN) 2021115196541

(51) Int. Cl. A01C 1/02; A01C 1/04

(52) U.S. Cl. CPC A01C 1/025; A01C 1/046

(57) ABSTRACT

Disclosed is a biomechanical measuring technical method for maize seed radicle and coleorhiza separation, which is characterized by comprising the following operations: (1) seed sample preparation; (2) anterior tissue cutting; (3) radicle and coleorhiza separation; (4) coleorhiza sample acquisition; (5) coleorhiza sample fixation; (6) puncture force measurement; (7) information storage and analysis. The operation (3) includes the development of a maize radicle and coleorhiza separation device, and the operation (5) includes the development of a maize coleorhiza sample carrier. The present disclosure has the beneficial effects of providing direct biomechanical evidence for the research on the coleorhiza weakening regulation and control mechanism of the maize seed germination, and simultaneously providing reference for measuring the coleorhiza weakening biological force of the gramineous plant seeds.

### CROSS-REFERENCE TO RELATED APPLICATIONS

This present disclosure claims priority to Chinese Patent Application 202111519654.1, filed on Dec. 14, 2021, the contents of which are hereby incorporated by reference.

### TECHNICAL FIELD

The present disclosure relates to the technical field of seed science, and in particular to a biomechanical measuring technical method for maize seed radicle and coleorhiza separation.

### BACKGROUND

Biomechanics, a new frontier discipline, which introduced mechanical methods into traditional biological research, was born in the 1980s, and soon developed into a hot research field in the world. However, for a long time, the research objects of biomechanics mainly focus on the medical problems related to animals and humans. As a natural branch of this discipline, plant mechanics is a new concept put forward in recent years, and has a huge scientific development space.

Plant growth and development will inevitably be stimulated by a variety of external environmental conditions, which is called environmental stress stimulation, including natural and man-made stress sources. In particular, the concept of environmental stress is much more extensive than the traditional study of plant growth from the perspective of light, temperature, water, minerals and so on. It has been known for a long time that stress stimulation can affect the growth of plants significantly, and it makes plants produce macro-biological effects due to stress stimulation. For example, the tropism of climbing plants growth changed; the stem of some plants becomes thicker and shorter and the growth of the root is hindered after being knocked; the periodic vibration caused by wind can have a significant impact on plant morphogenesis; sound stimulation of certain intensity can promote plant growth obviously; the shear force of water flow will affect the growth and morphology of aquatic plants. In addition, some progress has been made in the effects of mechanical oscillation stimulation, strong sound wave (or ultrasonic wave) stimulation, electric (magnetic) field and microgravity (space weightlessness environment) on plants. In particular, there have been some studies on the relationship between plant cell growth and stress stimulation, including stress load experiments on target tissues/cells in plant development to reveal the mechanism of intracellular stress signal transduction. Therefore, this field is full of charm and worth further study.

Yuan-Cheng Fung (Member of the National Academy of Sciences, the National Academy of Engineering, and the National College of Medicine), the founder of biomechanics, said: “The stress-growth relationship is the living soul of biomechanics”. This is especially true for plant mechanics. Physics provides modern experimental means and methods for botanical research, so biologists and physicists should vigorously carry out the research of this frontier discipline at this stage and in the future, create new methods and means into the research of traditional botany. This will promote botanical research to glow with new vitality.

Seeds, and in many cases also seed-harbouring fruits, evolved as the typical dispersal and propagation units of the angiosperms and gymnosperms. In the field of seed biophysics, there are many studies on the mechanical properties of seeds (fruits), such as fracture toughness, impact damage, tensile and compressive strength. At present, the mechanical properties of seeds (fruits) are mainly measured and evaluated, such as beans, olives, walnuts, sunflowers, wheat and so on, especially these mechanical properties mainly involve the effect of different moisture content on the mechanical properties of seeds (fruits).

By definition, seed germination starts with the uptake of water by the quiescent, dry seed followed by the elongation of the embryonic axis. This usually culminates in the rupture of the covering layers and emergence of the radicle, generally considered as the completion of germination. From a biomechanical perspective, the completion of seed (and fruit) germination depends on the balance of two opposing forces: the growth potential of the embryonic axis (radicle-hypocotyl growth zone) and the restraint of the seed-covering layers (endosperm, testa, and pericarp). The diverse seed tissues are composite materials which differ in their dynamic properties based on their distinct cell wall composition and water uptake capacities. The biomechanics of embryo cell growth during seed germination depend on irreversible cell wall loosening followed by water uptake due to the decreasing turgor, and this leads to embryo elongation and eventually radicle emergence. Endosperm weakening as a prerequisite for radicle emergence is a widespread phenomenon among angiosperms. At present, some review papers on the biochemical and molecular mechanisms of endosperm weakening have been published (e.g. Steinbrecher T, Leubner-Metzger G. 2017. The biomechanics of seed germination. Journal of Experimental Botany 68: 765-783.). In addition, our team (Gerhard Leubner-Metzger lab, http://www.seedbiology.de/index.html) has established a series of important plant seed research systems, including biomechanical methods such as puncture force measurement, and obtained direct evidence of endosperm weakening, where puncture force refers to the maximum mechanical strength of the tissue.

Sensing mechanical forces to control gene expression, tissue growth, and fate is an essential part of plant life. We propose that seeds constitute an excellent system for studying mechanosensing due to the striking interactions between seed-covering layers and the distinct fates leading either to growth (embryo) or to death (micropylar endosperm) of tissues. In the early stage, our team has carried out a lot of research work on the direct puncture force measurement of tomato, tobacco, lettuce, coffee and other species seed tissue strength (endosperm weakening, etc.) (http://www.seedbiology.de/index.html). Especially according to the types of plant seeds, we studied the biomechanical measurement methods of tissue strength (e.g. endosperm weakening) of different types of seeds, which provided direct biomechanical evidence for the further study of tissue weakening mechanism in seed phylogeny. For example, in order to study the basic biomechanical mechanism of tobacco endosperm weakening, we have just realized the measurement technology of endosperm weakening force of tiny seeds such as tobacco, and successfully analyzed and compared the puncture force of micropylar endosperms and chalazal endosperms (http://www.seedbiology.de/index.html).

The combination of molecular and biomechanical work is promising to unravel the underpinning mechanisms of the germination process and the endosperm weakening. Unravelling the complex regulation of seed germination and its molecular basis to understand the cell wall related changes in tissue mechanics in manifold species and with integrative approaches is needed to gain a comprehensive view on the germination process. Despite a strong enthusiasm to understand the vital process of seed germination, there are still open questions. The acquired evidence reveals that endosperm/coleorhiza weakening involves evolutionarily conserved as well as species-specific molecular, biochemical, and biomechanical mechanisms. Especially, it is very important to study and perfect the method of biomechanical measurement.

Maize is one of the most important food and forage crops in the world, which plays an important role in promoting the development of national agricultural economy. For example, in China, hybrid maize accounts for more than 95% of maize cultivation, and the annual demand for hybrid seeds is about 1.1 billion kilograms; and maize is also a very important food and feed crop in the United States. High-quality maize seed production is the fundamental to improve the level of modern agricultural development in an all-round way. Seed vigor is an important indicator of maize seed quality. High vigor seeds have the characteristics of rapid germination and strong resistance to adversity in the field emergence process. Coleorhiza, as a special tissue and organ of gramineous crops, play an important role in helping radicle break through that mechanical bondage of seed coat (Jiang et al. 2011. QTL mapping of coleorhiza length in maize (Zea mays L.) Plant Breeding 130: 625-632), which may have similar functions to other plant endosperms in regulating seed germination. At present, there are very few research reports on the direct biomechanical measurement of coleorhiza tissue, which is attributed to the great difficulty in the measurement technology, so we need to constantly explore and innovate technology to overcome the existing technical difficulties. Recently, our team has just solved the biomechanical measurement of wild oat coleorhiza and published a paper in the New Phytologist (Holloway et al. 2020. Coleorhiza enforced seed dormancy: a novel mechanism to control germination in grasses. New Phytologist 229: 2179-2191). However, there are a series of technical difficulties in the measurement of the biomechanics of maize coleorhiza, such as the difficult separation of radicle and coleorhiza in the early stage of seed germination, the selection of measurement model and the determination of measurement parameters, which need to be solved. In addition, maize seeds can provide an excellent biomechanical research system for gramineous plant seed coleorhiza weakening, and establish a set of scientific and effective technical methods for effectively measuring the biological force of coleorhiza weakening in the process of maize seed germination, which is of great significance for further studying the germination mechanism of gramineous crop seeds in the future.

### SUMMARY

The objective of the present disclosure is to provide a biomechanical measuring technical method for maize seed radicle and coleorhiza separation. This will meet the requirement of effective combination of biomechanics and molecular biology and solve a series of technical difficulties existing in coleorhiza weakening biological force measurement in maize seed germination mechanism research. The application of this technology will provide direct biomechanical evidence for the study of the mechanism of maize seed germination regulated by coleorhiza weakening.

In order to accurately measure the puncture force of coleorhiza tissue, the present disclosure provides a biomechanical measuring technical method for maize seed radicle and coleorhiza separation according to the unique structural characteristics of the maize seeds, an d the technical method comprises the development of a radicle and coleorhiza separation device and the like. This realizes the accurate collection of tissue biomechanical (puncture force) information in the process of maize coleorhiza weakening.

In order to achieve the above objective, the present disclosure adopts the following technical scheme to obtain a biomechanical measuring technical method for maize seed radicle and coleorhiza separation, which is characterized by comprising the following operations (FIG. 1): (1) seed sample preparation; (2) anterior tissue cutting; (3) radicle and coleorhiza separation; (4) coleorhiza sample acquisition; (5) coleorhiza sample fixation; (6) puncture force measurement; (7) information storage and analysis. The operation (3) includes the development of a maize radicle and coleorhiza separation device. And the operation (5) includes the development of a maize coleorhiza sample carrier.

In the operation (1), the germination environment and that sample time point of the seeds are determine according to the research requirement, and the seed samples to be measured are prepared. The germination method of maize seed can be carried out by referring to the methods introduced by the international rules for seed testing (International Seed Testing Association, ISAT). The method for maize seed germination mainly adopt ‘between paper’ germination (covering paper or rolling paper).

In the operation (2), under the microscope, according to the shape of the seed, the seed is transected with a scalpel, the anterior (seed micropylar end) tissue of seed containing radicle and coleorhiza is retained, and the posterior tissue of seed is discarded (FIG. 2).

In the operation (3), in order to achieve the separation of radicle and coleorhiza tissue, we developed a maize radicle and coleorhiza separator (FIG. 3 to FIG. 5), which includes a separator rotor, a miniature electric drill and a glass rotating tube. The maize radicle and coleorhiza separator is utilized to finish that radicle and coleorhiza separation. When the separator is used, the front end of the glass rotating tube is slightly with a lubricant, and then the rotating speed is controlled for flexible propulsion. In that process of tissue separation, when the front part of the glass tube is filled with residual tissue, the front end of the glass rotating tube can be broken and discarded, and then a new glass rotating tube is extended for continuously transferring tissue, including take out the radicle intact from the coleorhiza (FIG. 6).

The front part of the separator rotor is a separator cap, the rear part is an electric drill fixing shaft, and the middle part is provided with a connecting cap shaft, a connecting cap shaft thread, a connecting tail shaft and a connecting tail shaft thread.

The separator cap is provided with a glass rotating tube sleeve, a separator cap inner cavity and a separator cap inner cavity thread.

The electric drill fixing shaft is provided with a separator tail, a separator tail antiskid stripe and a glass rotating tube telescopic control button. The front part of the electric drill fixing shaft is provided with a separator tail inner cavity, a separator tail inner cavity thread and an electric drill fixing shaft clamping strip.

The inside of the separator rotor is provided with a glass rotating tube sleeve, a rubber ring, a separator transfer head inner groove, a tube stabilizer, a tube stabilize sleeve, a compression cap, a spring and a tube stabilizer buckle joint.

The miniature electric drill is provided with a rotor fixing clamp, a rotor fixer, an elastic ring, an elastic ring antiskid stripe, a speed change controller, a power switch, an electric drill fixing bayonet and a battery.

The battery is provided with a battery antiskid stripe. A charging interface is arranged at the bottom of the battery, and a charging plug and a power cord are arranged on the battery.

In the operation (4), under a stereoscope, after removing the radicle, the coleorhiza is acquisited from the anterior (seed micropylar end) tissue of seed by a scalpel and a forceps.

In that operation (5), a transparent module (a component of the tissue sample carrier) is processed and manufacture based on the 3D printing technology according to the structure of the maize coleorhiza, wherein the top surface of the transparent module is provide with a sample placing hole, and the bottom surface of the transparent module is provided with a needle outlet hole. A gasket is fixed on the transparent module and is provided with a gasket hole which corresponds to a sample placing hole on the top of transparent module. And the coleorhiza sample is fixed to be tested through the gasket hole and the sample placing hole on the top of the transparent module (FIG. 7).

In the operation (6), the tissue sample carrier on which the sample is placed is fixed on the sample determination platform, and the specified metal needle is selected and the measurement parameters are set to measure the puncture force of the coleorhiza tissue sample by using the seed biomechanical measuring system (FIG. 8).

In the operation (7), the coleorhiza biomechanical (puncture force) measurement information (image, data, etc.) is stored (FIG. 9), and target information is derived for statistical analysis.

### BRIEF DESCRIPTION OF THE DRAWINGS

In order to more clearly explain the embodiments of the present disclosure or the technical solutions in the prior art, the following will briefly introduce the drawings that need to be used in the embodiments. Obviously, the drawings in the following description are only some embodiments of the present disclosure. For those of ordinary skill in the art, other drawings may be obtained according to these drawings without any creative efforts.

In FIGS. 2 and 3, the meaning of each number is as follows: the separator cap 1, the connecting cap shaft 2, the connecting cap shaft thread 3, the separator rotor 4, the connecting tail shaft 5, the separator tail 6, the separator tail antiskid stripe 7, the electric drill fixing shaft 8, the glass rotating tube telescopic control button 9, the glass rotating tube 10, the glass rotating tube sleeve 11, the separator cap inner cavity 12, the separator cap inner cavity thread 13, the connecting tail shaft thread 14, the separator tail inner cavity 15, the separator tail inner cavity thread 16, the electric drill fixing shaft clamping strip 17, the rubber ring 18, the separator transfer head inner groove 19, the tube stabilizer 20, the tube stabilize sleeve 21, the compression cap 22, the spring 23, the tube stabilizer buckle joint 24, the miniature electric drill 25, the rotor fixing clamp 26, the rotor fixer 27, the elastic ring 28, the elastic ring antiskid stripe 29, the speed change controller 30, the power switch 31, the electric drill fixing bayonet 32, the battery 33, the battery antiskid stripe 34, the charging interface 35, the charging plug 36, the power cord 37, the metal needle 38, the coleorhiza 39, the gasket 40, the gasket hole 41, the transparent module 42, the sample placing hole 43 and the needle outlet hole 44.

FIG. 1 is a flow technical scheme of the operation of the present disclosure.

FIG. 2 is a schematic view showing the separation of anterior and posterior of seed of the present disclosure.

FIG. 3 is a perspective view of the structure of the separator rotor of maize radicle and coleorhiza separator of the present disclosure.

FIG. 4 is a perspective view of the internal structure of the separator rotor of the maize radicle and coleorhiza separator of the present disclosure.

FIG. 5 is a perspective view of the structure of the miniature electric drill matched with the maize radicle and coleorhiza separator of the present disclosure.

FIG. 6 is a diagram of maize seed of the present disclosure after radicle and coleorhiza separation.

FIG. 7 is a perspective view of coleorhiza sample fixation and puncture force measurement of the present disclosure.

FIG. 8 shows the seed biomechanical measuring system of the present disclosure.

FIG. 9 shows a coleorhiza sample puncture force measurement curves.

### DETAILED DESCRIPTION OF THE EMBODIMENTS

The technical solutions in the embodiments of the present disclosure will be clearly and completely described below with reference to the drawings in the embodiments of the present disclosure. Obviously, the described embodiments are only part of the embodiments of the present disclosure, but not all of them. Based on the embodiment of the present disclosure, all other embodiments obtained by ordinary technicians in the field without creative labor are within the scope of the present disclosure.

In order to make the above objectives, features and advantages of the present disclosure more obvious and understandable, the present disclosure will be explained in further detail below with reference to the drawings and detailed description.

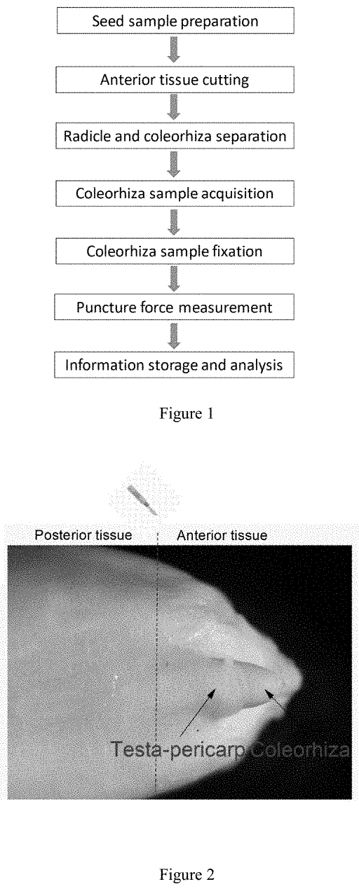

As shown in FIG. 1, biomechanics and molecular biology are effectively combined by measure the biological force of the seeds, so that the growth rule of the seeds can be better discover, and the related mechanism can be clarified. The present disclosure relates to a biomechanical measuring technical method for maize seed radicle and coleorhiza separation, which comprises the following operations: seed sample preparation; anterior tissue cutting; radicle and coleorhiza separation; coleorhiza sample acquisition; coleorhiza sample fixation; puncture force measurement; information storage and analysis. The present disclosure also comprises the completion of the research and development of a maize radicle and coleorhiza separator and the like to meet the requirements of related operations. The application of this technology will provide direct biomechanical evidence for the mechanism of maize seed germination regulated by coleorhiza weakening.

The present disclosure relates to a technical method for determining the biological force of maize seed radicle and coleorhiza separation, and the detailed description of the embodiments is as follow.

(1) Seed sample preparation: Biomechanical measurement of coleorhiza weakening mainly adopts two seed germination methods of covering paper germination and rolling paper germination, the details are as follows.

Seeds are randomly selected for germination and surface sterilized for ten minutes in 1% NaClO (w/v) and then wash thrice with distilled water (the coated seeds are cleaned with distilled water before surface sterilization). For rolled paper germination, two pieces of germination paper (Anchor Paper Co., St Paul, Minn., USA) are stacked and wet by distilled water. Excess water on the paper is removed by a towel, then the sterilized seeds are placed in a loose vertical roll of germination paper and incubated in a versatile environmental test chamber. The specific germination environment and seed treatment method are selected according to the scientific research purpose.

Germination by covering paper method: We take two pieces of germination paper (380 mm×255 mm) and stack them into a germination box/tray (450 mm×300 mm×90 mm), then add distilled water to fully wet them, and then lightly wipe the bed surface with sterile gauze to remove the residual liquid and air bubbles between the papers. The seeds are arranged in parallel and orderly on the germinating paper with the assistance of a seed placing plate which is an auxiliary tool for placing seed, with the paper edge distance of 2-2.5 cm. After the seeds are placed on the germination paper, a piece of moistened germination paper is covered on the seeds, then a germination box/tray cover is covered, a label is pasted on the germination box/tray and basic information such as variety name, sample number, repetition times, germination time and the like is marked, and finally the germination box/tray is placed in versatile environmental test chamber for germination.

Rolling paper germination: We sterilize the operating table with 75% alcohol solution, stack two pieces of germination paper (380 mm×255 mm), and mark the sample information (or prepare a waterproof strip for sample information) in the smaller area of the germination paper corner with an oily marker pen, such as sample name, repeat number, etc. The germinate paper is fully wet by distilled water, that paper surface is lightly wiped by sterile gauze, after the residual liquid and the air bubbles between the papers are removed. Then the seeds are arranged on the germination paper in a staggered way under the assistance of a seed placing plate. The micropylar end of each seed is in the same direction when the seeds are placed; and the paper edge distance is 5 cm. After the seeds are placed on the germination paper, a piece of moistened germination paper is covered on the seeds. Then roll up the germination papers (Note: here the sample information waterproofing strip could be placed between germination papers). Then the ends of the paper roll are fixed with rubber bands. The paper rolls are put into a plastic self-sealing bag to be sealed; and label paper is stuck on the plastic self-sealing bag or relevant information is marked by an oily marker pen, and then the plastic self-sealing bag containing the paper rolls is vertical placed in versatile environmental test chamber for germination (seed micropylar end down).

(2) Anterior tissue cutting: The seeds to be tested from the germinating paper are taken out (Note: the sampling time shall be determined according to the needs of scientific research). The seeds are transected with a scalpel (FIG. 2). The anterior tissue of the seed is retained and placed on wet filter paper for later use. The posterior tissue of the seed is discarded.

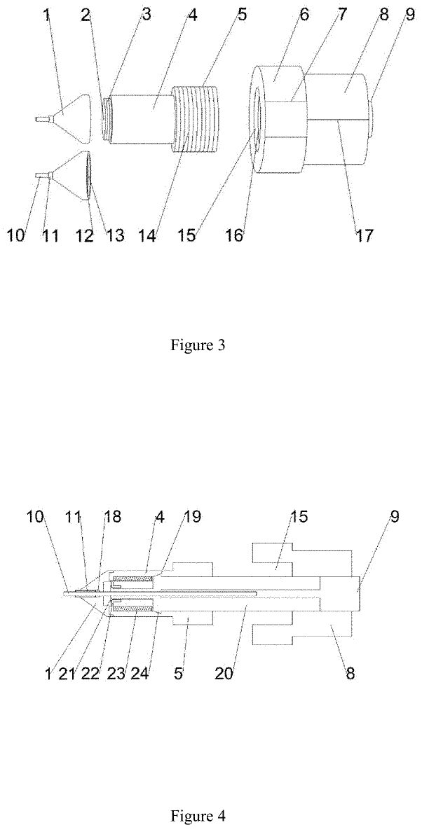

(3) Radicle and coleorhiza separation: Accord to that characteristics of the maize variety and the inn diameter of the coleorhiza of a sample to be tested, and the glass rotating tube 10 is arranged in a radicle and coleorhiza separator (The specific structure and usage of the radicle and coleorhiza separator are described below). The radicle is separated from the coleorhiza by rotating the glass rotating tube, and is moved out from coleorhiza. Before being used, the opening of the glass rotating tube is slightly dipped with a lubricant (such as liquid paraffin); and particularly, when the radicle and coleorhiza are tightly connected at the initial stage of seed germination, the glass rotating tube needs to be slowly rotated forward. The separated sample is shown in FIG. 3.

(4) Coleorhiza sample acquisition: After that radicle is removed from the coleorhiza, the coleorhiza in the seed anterior tissue is completely peel off by a scalpel, forceps and the like under a stereoscope. The tissue is soaked with sterile water by a dropper to facilitate stripping and avoid damaging the integrity of the coleorhiza.

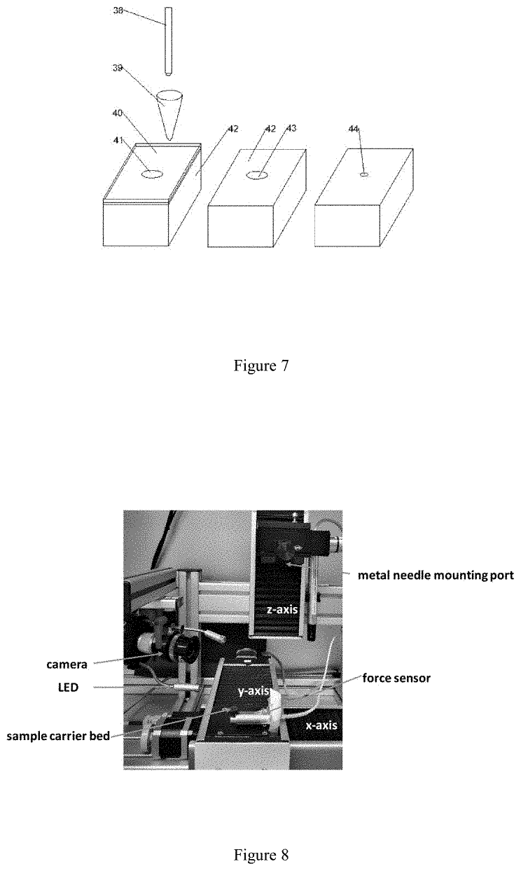

(5) Coleorhiza sample fixation: The coleorhiza sample is transferred to a special coleorhiza sample carrier (FIG. 7). And the coleorhiza sample carrier comprises a transparent module 42 and a gasket 40; and the transparent module 42 is processed and manufactured on the basis of a 3D printing technology. The gasket 40 is fixed on the transparent module 42. And the coleorhiza sample is fixed through a gasket hole 41 and a sample placing hole 43 on the top of the transparent module 42.

(6) Puncture force measurement: The tissue sample carrier is fixed on a sample carrier bed (FIG. 8). A small amount of sterile water is dripped on a gasket 40 before measurement to ensure that sample is wet. Then the seed biomechanical measurement system (FIG. 8) is utilized to measure the puncture force of the coleorhiza sample. In the process of coleorhiza sample puncture force measurement, the metal needle 38 sequentially passes through the gasket hole 41, the sample placing hole 43, the coleorhiza 39 and the needle outlet hole 44. The measuring parameters are as follows: the needle diameter is 0.5 mm, the needle moving speed is 30 mm·minute⁻¹, the test ambient temperature is 15-20° C., and the completion time is within 30 minutes (min). After biomechanical measurement, the tissue sample carrier is cleaned, the needle is unloaded, and various system components return to the original position.

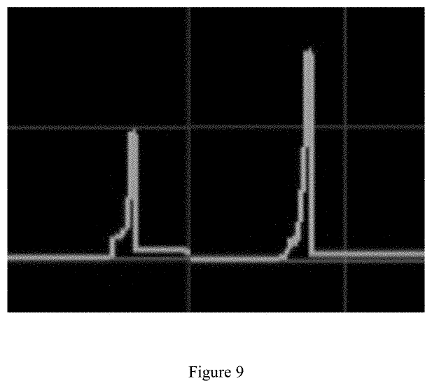

(7) Information storage and analysis: The seed biomechanical measurement system is used to obtain the information of maize coleorhiza puncture force. The information (including the puncture force measurement curves, see FIG. 9) is stored and the target data is statistically analyzed.

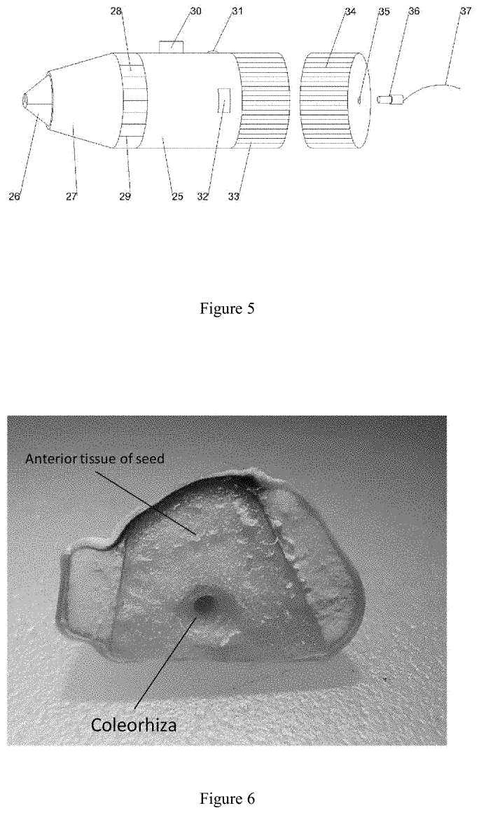

In the operation (3), the maize radicle and coleorhiza separator (FIG. 3, FIG. 4, FIG. 5) comprises a separator rotor 4, a miniature electric drill 25 and a glass rotating tube 10. Wherein, the separator rotor 4 comprises a separator cap 1, a connecting cap shaft 2, a connecting cap shaft thread 3, a connecting tail shaft 5, a separator tail 6, a separator tail antiskid stripe 7, an electric drill fixing shaft 8, a glass rotating tube telescopic control button 9, a glass rotating tube sleeve 11, a separator cap inner cavity 12, a separator cap inner cavity thread 13, a connecting tail shaft thread 14, a separator tail inner cavity 15, a separator tail inner cavity thread 16, an electric drill fixing shaft clamping strip 17, a rubber ring 18, a separator transfer head inner groove 19, a tube stabilizer 20, a tube stabilize sleeve 21, a compression cap 22, a spring 23, a tube stabilizer buckle joint 24. The miniature electric drill 25 comprises a rotor fixing clamp 26, a rotor fixer 27, an elastic ring 28, an elastic ring antiskid stripe 29, a speed change controller 30, a power switch 31, an electric drill fixing bayonet 32, a battery 33, a battery antiskid stripe 34, a charging interface 35, a charging plug 36 and a power cord 37.

The front part of the separator rotor 4 is the separator cap 1. The rear part of the separator rotor 4 is the electric drill fixing shaft 8. The separator tail inner cavity 15 of the separator cap 1 with the separator cap inner cavity thread 13 and the connecting cap shaft 2 with the connecting cap shaft thread 3 are fixed by rotating connection.

The front part of the separator cap 1 is provided with a glass rotating tube sleeve 11. Inside the separator cap 1 there is a rubber ring 18, which is behind the glass rotating tube sleeve 11 and serves to fix the glass rotating tube 10. The tube stabilizer buckle joint 24 is clamped in the separator transfer head inner groove 19 and used for fixing the tube stabilizer 20. The tube stabilize sleeve 21 is sleeved on the compression cap 22. When the spring 23 extends the tube stabilize sleeve 21 will compress the compression cap 22. The glass rotating tube telescopic control button 9 controls the compression and extension of the spring 23 so as to control the length of the glass rotating tube 10 at the front end of the glass rotating tube sleeve 11. And when that glass rotating tube 10 is arranged in the tube stabilizer 20, the glass rotary tube telescopic control button 9 can be taken down. The rear part of the separator rotor 4 is provided with the electric drill fixing shaft 8 which is provided with the electric drill fixing shaft clamping strip 17 which can be tightly fixed with the rotor fixing clamp 26 of the miniature electric drill 25.

The front part of the miniature electric drill 25 is provided with a rotor fixer 27. The rotor fixer 27 top is provided with a rotor fixing clamp 26. The rotor fixer 27 rear is provided with an elastic ring 28. The rotor fixing clamp 26 is opened or closed by rotating the elastic ring 28 through the elastic ring antiskid stripe 29. And this is very convenient for installing and removing the separator rotor 4. The middle part of the miniature electric drill 25 is provide with a power switch 31 and a speed change controller 30. The power switch 31 controls whether the miniature electric drill 25 work. The rotational direction and speed of the rotor fixing clamp 26 are controlled by changing the direction of the speed change controller 30 and changing the pressure applied to the speed change controller 30, respectively. In addition, the middle part of the miniature electric drill 25 is provided with two electric drill fixing bayonet 32. And the miniature electric drill 25 can be fixed on a specific electric drill frame through the electric drill fixing bayonet 32 as required. The rear part of the miniature electric drill 25 is provided with a battery 33. The surface of the battery 33 is provided with a battery antiskid stripe 34. And the battery antiskid stripe 34 can facilitate the unloading of the battery 33. The bottom of the battery 33 is provided with a charging interface 35. When charging, the charging plug 36 is inserted into the charging interface 35; and the power cord 37 is connected with the power supply.

There are two ways to install the glass rotating tube 10. One is to remove the glass rotating tube telescopic control button 9, and put the glass rotating tube 10 from the rear of the tube stabilizer 20. And the other is to press the glass rotating tube telescopic control button 9 to directly put the glass rotating tube 10 into the tube stabilizer 20 from the front end of the glass rotating tube sleeve 11.

In summary, the present disclosure can provide direct biomechanical (puncture force) evidence for the study of coleorhiza weakening mechanism during maize seed germination.

The above-mentioned embodiments only describe the preferred mode of the present disclosure, but do not limit the scope of the present disclosure. On the premise of not departing from the design spirit of the present disclosure, all kinds of modifications and improvements made by ordinary technicians in the field to the technical scheme of the present disclosure shall fall within the scope of protection determined by the claims of the present disclosure.

What is claimed is:

1. A biomechanical measuring technical method for maize seed radicle and coleorhiza separation, which is characterized by comprising the following operations: (1) seed sample preparation; (2) anterior tissue cutting; (3) radicle and coleorhiza separation; (4) coleorhiza sample acquisition; (5) coleorhiza sample fixation; (6) puncture force measurement; (7) information storage and analysis;
the operation (3) includes the development of a maize radicle and coleorhiza separation device, which is characterized by comprising a separator rotor (4), a miniature electric drill (25) and a glass rotating tube (10); the front part of the separator rotor (4) comprises a separator cap (1); the middle part of the separator rotor (4) comprises a connecting cap shaft (2), a connecting cap shaft thread (3), a connecting tail shaft (5), a connecting tail shaft thread (14); the separator cap (1) comprises a glass rotating tube sleeve (11), a separator cap inner cavity (12), a separator cap inner cavity thread (13); the electric drill fixing shaft (8) comprises a separator tail (6), a separator tail antiskid stripe (7), a glass rotating tube telescopic control button (9), a separator tail inner cavity (15), a separator tail inner cavity thread (16), an electric drill fixing shaft clamping strip (17); the interior of the separator rotor (4) has a glass rotating tube sleeve (11), a rubber ring (18), a separator transfer head inner groove (19), a tube stabilizer (20), a tube stabilize sleeve (21), a compression cap (22), a spring (23), a tube stabilizer buckle joint (24); the miniature electric drill (25) comprises a rotor fixing clamp (26), a rotor fixer (27), an elastic ring (28), an elastic ring antiskid stripe (29), a speed change controller (30), a power switch (31), an electric drill fixing bayonet (32) and a battery (33); the battery (33) has a battery antiskid stripe (34), a charging interface (35) at the bottom, a charging plug (36) and a power cord (37);
the operation (5) includes the development of a maize coleorhiza sample carrier comprises a transparent module (42) and a gasket (40); and the transparent module (42) is processed and manufactured on the basis of a 3D printing technology; the gasket (40) is fixed on the transparent module (42) and is provided with a gasket hole (41) which corresponds to a sample placing hole (43) on the top of the transparent module (42);
in the operation (1), the seeds are germinated by adopt two germination methods of covering paper germination and rolling paper germination;
in the operation (2), the seed is transected with a scalpel, the anterior tissue of seed containing radicle and coleorhiza is retained and placed on wet filter paper for later use, and the posterior tissue of seed is discarded;
in the operation (3), accord to that characteristics of the maize variety and the inn diameter of the coleorhiza of a sample to be tested, and the glass rotating tube is arranged in the radicle and coleorhiza separator; the radicle is separated from the coleorhiza by rotating the glass rotating tube, and is moved out from coleorhiza;
before being used, the opening of the glass rotating tube is slightly dipped with a lubricant; and particularly, when the radicle and coleorhiza are tightly connected at the initial stage of seed germination, the glass rotating tube needs to be slowly rotated forward;
in the operation (4), after that radicle is removed from the coleorhiza, the coleorhiza in the seed anterior tissue is completely peel off by a scalpel, forceps and the like under a stereoscope; the tissue is soaked with sterile water by a dropper to facilitate stripping and avoid damaging the integrity of the coleorhiza;
in the operation (5), the coleorhiza sample is transferred to a special coleorhiza sample carrier;
in the operation (6), the tissue sample carrier is fixed on a sample carrier bed; a small amount of sterile water is dripped on a gasket before measurement to ensure that sample is wet; then the seed biomechanical measurement system is utilized to measure the puncture force of the coleorhiza sample; the measuring parameters are as follows: the needle diameter is 0.5 mm, the needle moving speed is 30 mm·min⁻¹, the test ambient temperature is 15-20° C., and the completion time is within 30 min; after biomechanical measurement, the tissue sample carrier is cleaned, the needle is unloaded, and various system components return to the original position;
in the operation (7), the seed biomechanical measurement information is stored and the target data is statistically analyzed.

2. The biomechanical measuring technical method for maize seed radicle and coleorhiza separation according to claim 1, which is characterized in that: in the operation (5), the coleorhiza sample is fixed through the gasket hole (41) and the sample placing hole (43) on the top of the transparent module (42); in the process of coleorhiza sample puncture force measurement, the metal needle (38) sequentially passes through the gasket hole (41), the sample placing hole (43), the coleorhiza (39) and the needle outlet hole (44).
